(19) United States
(12) Patent Application Publication
(10) Pub. No.: US 2009/0098371 A1
(43) Pub. Date: Apr. 16, 2009

(54) ENAMEL COMPOSITION FOR APPLICTION AS DIELECTRIC, AND USE OF SUCH AN ENAMEL COMPOSITION

(76) Inventors: Simon Kaastra, Dinxperlo (NL); Rudi Meinen, Aalten (NL)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/719,788

(22) PCT Filed: Nov. 23, 2005
(86) PCT No.: PCT/NL2005/050049

§ 371 Date: Dec. 9, 2008

(30) Foreign Application Priority Data
Nov. 23, 2004 (NL) 1027571

(51) Int. Cl. C03C 8/00; B32B 15/04; B05D 3/02

(52) U.S. Cl. 428/334; 501/14; 428/432; 427/397.7

(57) ABSTRACT

The invention relates to an enamel composition for application as dielectric. The invention also relates to the use of such an enamel composition for application as dielectric. The invention further relates to a dielectric layer with such an enamel composition. In addition, the invention relates to an assembly of such a dielectric layer and a support structure manufactured at least partially from stainless steel, wherein the dielectric player is arranged on a part of the support structure manufactured from stainless steel. The invention moreover relates to a method for manufacturing such an assembly.

The invention relates to an enamel composition for application as dielectric. The invention also relates to the use of such an enamel composition for application as dielectric. The invention further relates to a dielectric layer with such an enamel composition. In addition, the invention relates to an assembly of such a dielectric layer and a support structure manufactured at least partially from stainless steel, wherein the dielectric player is arranged on a part of the support structure manufactured from stainless steel. The invention moreover relates to a method for manufacturing such an assembly.

The use of enamel as dielectric intermediate layer in the manufacture of heating elements is known. Metal tracks are herein arranged on the dielectric enamel layer, generally by means of silkscreen techniques. By conducting electric current through the metal tracks heat can be generated which can then be usefully applied, for instance to heat liquids. The manufacture of the dielectric from enamel herein results in a mechanically relatively strong dielectric which conducts heat relatively well, and which conducts electricity and magnetic radiation relatively poorly. An enamel dielectric can moreover be arranged relatively simply on both plane surfaces and curved surfaces, such as for instance tubes. The composition of the enamel for application as dielectric is however critical in order to enable optimization of the electrical properties, particularly at high temperatures (>400° C.). The specific electrical resistance of the dielectric is generally highly at room temperature, usually higher than 10¹² Ω□cm, and falls sharply as temperatures increase to about 10⁵ Ω□cm at 400° C. The magnitude of the leakage current can be regulated by means of alkali metal oxides forming part of the enamel composition. Detection of the leakage current can provide relevant information in respect of the temperature of the heating element, and usually also in respect of the temperature of a medium heated by the heating element. Another property which determines the quality, and thereby the applicability, of the dielectric is the breakdown voltage. In order to allow optimum functioning of the dielectric the breakdown voltage must be maximized irrespective of the temperature of the dielectric layer. The breakdown voltage of the dielectric is herein determined by multiple factors, including among others the layer thickness of the dielectric, the enamel composition, pores extending in the dielectric, contamination of the enamel and the size of gas bubbles enclosed in the dielectric. It is generally assumed that the formation of gas bubbles in the enamel during the melted state of the enamel is the most relevant cause of the (significant) reduction in the ideal breakdown voltage. Tests have shown that multiple causes underlie the (permanent) formation of gas bubbles in the enamel layer. Absorption of atmospheric carbon dioxide by the melted enamel for instance generally, always takes place, whereby gas bubbles are formed in the enamel. Furthermore, atmospheric air (or some other type of gas) is usually included by the enamel during the application of the melted enamel to a support structure, whereby gas bubble formation likewise occurs.

The invention has for its object to provide an improved enamel composition with which the formation of gas bubbles in the dielectric can be prevented, or at least countered.

The invention provides for this purpose an enamel composition of the type stated in the preamble, wherein the enamel composition comprises a quantity of vanadium oxide lying between 0 and substantially 10% by mass, more preferably between 0 and 5% by mass. Tests have shown that by adding a fraction of vanadium oxide to the enamel composition gas bubble formation in the enamel can be countered, and gas bubbles possibly still formed in the enamel can be forced relatively effectively and (almost) completely out of the enamel. The ability to close the enamel layer relatively gradually due to the presence of the vanadium oxide in all likelihood plays an important part in being able to prevent inclusion of relatively large gas bubbles in the enamel layer. In this manner a relatively compact enamel can be formed with a relatively dense, non-porous structure, which considerably increases the breakdown voltage. Test results have shown that the breakdown voltage of a dielectric formed by the enamel composition can be increased by at least 500% compared to the maximum breakdown voltage which can be achieved with a conventional enamel composition. Furthermore, using the improved enamel composition according to the invention a relatively high compressive stress (about 2.2×10⁸ Pa instead of about 1.1×10⁸ Pa) can also be generated in the dielectric to be formed, whereby crack formation and an associated reduction of the breakdown voltage can likewise be prevented. In contrast to the breakdown voltage of a conventional enamel composition, the breakdown voltage of the improved enamel composition has a substantially constant value through time irrespective of the number of cycles in which the enamel composition is heated and further cooled, which makes the enamel composition more durable. Tests have shown that in a conventional dielectric breakdown occurs in the case the dielectric is subjected to an alternating current for several days. This is a particular consequence of the high degree of polarization, whereby considerable degradation of the dielectric occurs. These adverse effects of relatively rapid degradation and the consequent relatively rapid breakdown of the dielectric can be prevented using the enamel composition according to the invention. An additional significant advantage of the enamel composition according to the invention is that by adding the vanadium oxide a significantly better adhesion of the enamel to a support structure can be obtained compared to conventional enamels. Tests have shown here that the improved enamel composition adheres to a support structure up to about 400% better than the conventional enamel, depending on the concentration of vanadium oxide in the enamel composition. The improved enamel composition according to the invention is character d by a relatively high compressive stress, a relatively high softening temperature and a relatively low dielectric constant and an associated relatively high breakdown voltage, which makes the enamel composition particularly suitable for application as dielectric in diverse applications, such as for instance a heating element. It is noted for the sake of clarity that the content of vanadium oxide lies at least between 0 and 100/by mass, which implies that vanadium oxide will be present in any embodiment variant of the enamel composition according to the invention so as to be able to impart the above stated advantageous properties to the enamel composition.

Vanadium oxide is in fact formed by a family of compounds between vanadium and oxygen, these compounds being distinguished by the oxidation number of the vanadium. The vanadium family is herein formed by the following compounds: VₙO₂ₙ₋₁ (such as VO, V₂O₃ and V₃O₅), Vₙf₂ₙ₊₁ (such as V₂O₅) and VO₂. The vanadium oxide applied in the enamel composition is preferably formed substantially by V₂O₅, since this compound is relatively stable, and/or will be formed from another vanadium oxide during melting of the enamel composition at high temperature (>660° C.).

In order to construct the glass lattice of the enamel composition in sufficiently reliable and durable manner, the enamel composition preferably comprises between 5 and 13% by mass of B₂O₃, and between 33 and 53% by mass of SiO₂. The enamel composition preferably also comprises between 5 and 15% by mass of Al₂O₃, and/or between 0 and 10% by mass of BiO2, in order to further improve the lattice structure of the enamel composition. In order to improve the viscosity of the enamel the enamel composition is more preferably provided with between 20 and 30% by mass of CaO and/or between 0 and 10% by mass of PbO. In addition, the enamel composition preferably comprises between 0 and 10% by mass of alkali metal oxides, on the one hand 10 enable optimization of the leakage current at high temperatures of the enamel composition, and thereby the regulating temperature, and on the other to increase the compressive stress of the enamel composition sufficiently to be able to counter crack formation, and thereby a significant reduction in the breakdown voltage. The alkali metal oxides are more preferably formed by oxides of one or more of the following metals: lithium, sodium, potassium, rubidium and caesium. It is however generally important to be able to melt the enamel composition at low temperature (<1000° C.) to allow subsequent processing of the enamel. Test results have shown her that the total of the mass fractions of PbO, V₂O₅ and BiO₂ must preferably amount to more than 4% by mass in order to enable relatively easy melting of the enamel composition at low temperatures.

The invention also relates to the use of the enamel composition according to the invention for application as dielectric.

The invention subsequently relates to a dielectric layer with an enamel composition according to the invention. The enamel composition can in fact be used for diverse applications in which a bubble-free glass, in particular dielectric, is required or at least desirable. It is therefore also possible to envisage having glass fibres formed by the enamel composition according to the invention. In addition, the enamel composition can be incorporated into for instance printed circuit boards (PCBs) and other types of application. The dielectric layer is however preferably applied as component in a heating element, such as for instance specified and shown in the Netherlands patent NL 1014601.

The invention further relates to an assembly of such a dielectric layer and a support structure manufactured at least partially from (ferritic) stainless steel (preferably AISI 430 and/or AISI 444), wherein the dielectric layer is applied to a part of the support structure manufactured from stainless steel. The support structure is more preferably manufactured wholly from stainless steel. The support structure will in that case generally be given a plate-like form. It is however also possible to envisage interpreting the support structure more broadly, wherein the support structure can for instance be seen as a liquid container, wherein using a heating element the liquid can be heated via the enamel dielectric. The layer thickness of the dielectric layer preferably lies substantially between 60 micrometres and 200 micrometres, more preferably between 60 and 120 micrometres. Because the formed enamel layer has a bubble-free and therefore relatively reliable and robust construction, it is possible to suffice with the above-mentioned relatively small layer thickness (compared to a conventional layer thickness of about 140 micrometres) in order to provide a reliable dielectric with a relatively high breakdown voltage. It will be apparent that a smaller layer thickness will result in a material saving, which is usually attractive from an economic viewpoint In a particular preferred embodiment the assembly is formed by a heating element, wherein a side of the dielectric layer remote from the support structure is provided with heat-generating means. The heat-generating means will generally be formed here by one or more metal tracks which are applied as thick film to the enamel coating.

The invention also relates to a method for manufacturing an above stated assembly, comprising the steps of: a) applying enamel to at least a part of the part of the support structure manufactured from stainless steel, and b) burning the enamel onto the support structure. Burning of the enamel onto the support structure as according to step b) preferably takes place at a temperature of between 840° C. aid 940° C. The applying of the enamel to the support structure as according to step a) preferably takes place by means of a wet spraying technique, a silkscreen technique or an immersion technique. A quantity of enamel is preferably applied to the support structure during step a) such that the final layer thickness of the enamel, after performing step b), lies substantially between 80 micrometres and 135 micrometres.

The method can be elucidated on the basis of Se following non-limitative experiment descriptions.

### EXAMPLE 1

Enamel frit A was melted using traditional rotating melting methods by mixing different raw materials in the correct ratio, whereby a glass resulted after melting with the following composition: B₂O₃: 8% (m/m); SiO₂: 45% (m/m); V₂O₅: 3% (m/m); Al₂O₃: 10% (m/m); CaO: 28% (n/n); PbO: 6% (m/m) (total 100% m/m)). This glass enamel frit was then ground with a conventional ball mill to form an enamel slurry with a fineness of 1-2 B 25600 #. This enamel slurry had the following composition: enamel frit A 100 parts by weight; zircon silicate 10 parts by weight; and water 55 parts by weight. After grinding and sieving over a 100 mesh sieve, the enamel was sprayed onto a stainless steel substrate (AISI 444) and burned onto this substrate at a temperature of 920° C. The layer thickness after burning amounted to 120±10 micrometres.

### EXAMPLE 2

Identical to example 1, but with Enamel frit B having the following composition (after melting): B₂O₃: 8% (m/m); SiO₂: 45% (m/m); V₂O₅: 5% (m/m); Al₂O₃: 10% (m/m); CaO: 25% (m/m); PbO: 4% (m/m); Li₂O: 3% (m/m) (total 100% m/m)).

It will be apparent that the invention is not limited to the exemplary embodiments described here, but that within the scope of the appended claims numerous variants are possible which will be self-evident to the skilled person in this field.

1. Use of an enamel composition for application as dielectric, the enamel composition comprising a quantity of vanadium oxide lying between 0 and substantially 10% by mass.

2. Use of an enamel composition as claimed in claim 1, characterized in that the vanadium oxide is formed substantially by V₂O₅.

3. Use of an enamel composition as claimed in claim 1, characterized in that the enamel composition also comprises between 5 and 13% by mass of B₂O₃, between 33 and 53% by mass of SiO₂, between 5 and 15% by mass of Al₂O₃ and between 20 and 30% by mass of CaO.

4. Use of an enamel composition as claimed in claim 1 characterized in that the enamel composition further comprises between 0 and 10% by mass of PbO and/or between 0 and 10% by mass of BiO₂.

5. Use of an enamel composition as claimed in claim 1 characterized in that the enamel composition comprises between 0 and 10% by mass of alkali metal oxides.

6. Use of an enamel composition as claimed in claim 5, characterized in that the alkali metal oxides are formed by oxides of one or more of the following metals: lithium, sodium, potassium, rubidium and caesium.

7. Dielectric layer with an enamel composition as claimed in claim 1.

8. Assembly of a dielectric layer as claimed in claim 7 and a support structure manufactured at least partially from stainless steel, wherein the dielectric layer is applied to a part of the support structure manufactured from stainless steel.

9. Assembly as claimed in claim 8, characterized in that the layer thickness of the dielectric layer lies substantially between 115 micrometres and 130 micrometres.

10. Assembly as claimed in claim 8, characterized in that the assembly is formed by a heating element, wherein a side of the dielectric layer remote from the support structure is provided with heat-generating means.

11. Method for manufacturing an assembly as claimed in claim 8, comprising the steps of:
a) applying enamel to at least a part of the part of the support structure manufactured from stainless steel, and
b) burning the enamel onto the support structure.

12. Method as claimed in claim 11, characterized in that burning of the enamel onto the support structure as according to step b) takes place at a temperature of between 840° C. and 940° C.

13. Method as claimed in claim 11, characterized in that applying of the enamel to the support structure as according to step a) takes place by means of a wet spraying technique.

14. Method as claimed in claim 11, characterized in that a quantity of enamel is applied to the support structure during step a) such that the final layer thickness of the enamel, after performing step b), lies substantially between 60 micrometres and 200 micrometres.
